(19) United States
(12) Patent Application Publication
(10) Pub. No.: US 2014/0026376 A1
(43) Pub. Date: Jan. 30, 2014

(54) Safety Link

(71) Applicant: Martin Phillip Bruce Smith, New Market (GB)

(72) Inventor: Martin Phillip Bruce Smith, New Market (GB)

(73) Assignee: SAFETY RELEASE LTD., Suffolk (UK)

(21) Appl. No.: 13/982,301

(22) PCT Filed: Mar. 23, 2012
(86) PCT No.: PCT/IB12/00594

§ 371 Date: Oct. 16, 2013

(30) Foreign Application Priority Data
Jan. 28, 2011 (GB) 1101484.2

(51) Int. Cl. F16G 11/00

(52) U.S. Cl. CPC F16G 11/00
USPC 24/602

(57) ABSTRACT

A device (2) which can be formed into safety link comprising a flexible, longitudinally elongate member having engagable first and second portions (4, 6); the first end portion (4) including a recess (8) which is open-ended in the longitudinal direction and defined, at least in part, by a pair of opposed interior side walls (10, 12); the second end portion (6) having sidewalls (18, 20) that are complementary to the sidewalls (10, 12) of the recess (8) so that the second end portion (6) is a push-fit in the recess (8); at least one pair of the complementary side-walls being non-planar so as to retain the first end portion (4) in the recess (8) against a longitudinally applied force until it is sufficient to move the side-walls (10, 12) of the recess (8) apart to release the second end portion (6) from the recess.

This invention relates to safety links and, in particular, to a device which can be formed into safety link, ie which will fail in a designed manner should a sufficiently high load be applied to the safety link.

Such links have a particular application in tying up horses to some object where it is essential the horse can break free if panicked. If the horse cannot break free in such a circumstance it is very like that the horse will injure itself with potential fatal consequences.

A simple form of safety link is one made of baling twine which will break as the weakest link if a sufficiently high load is placed on it by the horse. This type of safety link has the disadvantage that breaking load is indefinite being dependent on the material to hand and so it can easily happen that the breaking load is too high. Such links are also inconvenient as a new link has to be tied in place whenever the horse is tied up.

The present invention provides a device which can be formed into an improved safety link comprising a flexible, longitudinally elongate member having engageable first and second portions; the first end portion including a recess which is open-ended in the longitudinal direction and defined, at least in part, by a pair of opposed interior side walls; the second end portion having sidewalls that are complementary to the sidewalls of the recess so that the second end portion is a push-fit in the recess; at least one pair of the complementary sidewalls being non-planar so as to retain the first end portion in the recess against a longitudinally applied force until it is sufficient to move the sidewalls of the recess apart to release the second end portion from the recess.

The device is readily formed into a safety link manually whilst being able to secure a horse against usual forces expected to be applied to the horse and which opens non-destructively if forces above a predetermined size are applied to the safety link should the horse panic, for example.

One or both pairs of complementary sidewalls may be non-planar sidewalls being corrugated with a repeating pattern so that the second end is push-fit engageable in two or more longitudinal positions within the recess and the sidewalls of the recess more readily moved apart nearer the open end of the first end portion which provides that the opening force is adjustable and so the safety link may be used with different sizes of animals.

Conveniently the device is one piece and formed of a suitable plastics material such as low density polyethylene.

The floor of the recess may have a depression whose width and depth each tapers inwards from the open end of the recess to form a hinge substantially in the shape of a longitudinally sectioned cone which is a particularly convenient way of providing that the sidewalls of the recess more readily moved apart nearer the open end of the first end portion.

The second end portion including a region of reduced thickness defining the weakest portion of the member which provides the link will break on application of a predetermined force if, for any reason, the first and second end portions do not come apart at the designed force.

Embodiments of the invention will now be described, by way of example only, with reference to the accompanying drawings of which:

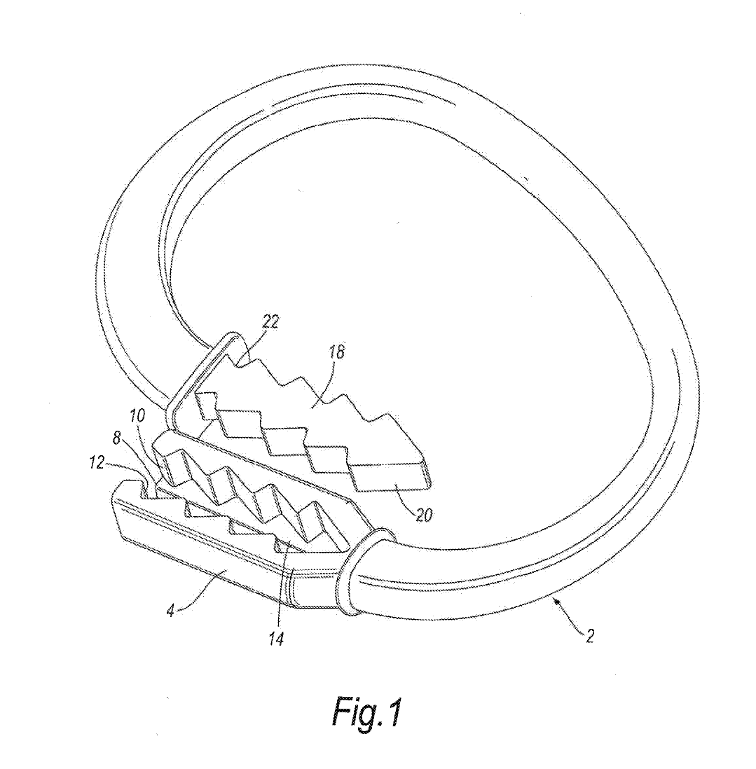

FIG. 1 is a top perspective view of a safety link according to the present invention.

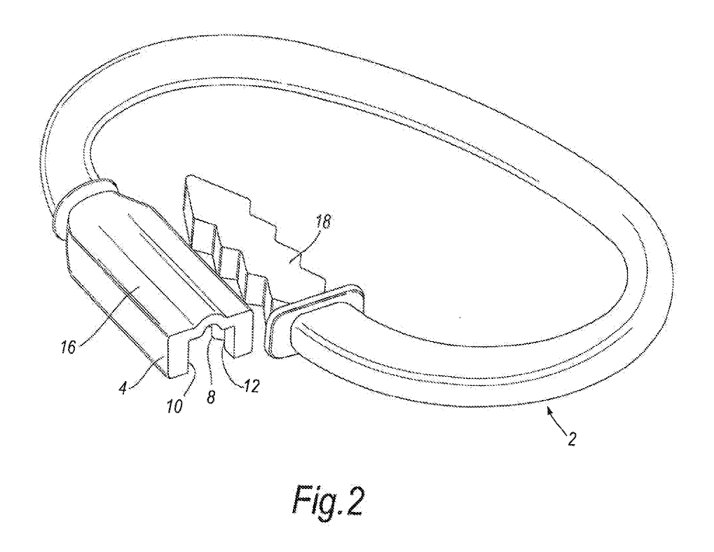

FIG. 2 is a bottom perspective view of the safety link of FIG. 1; and

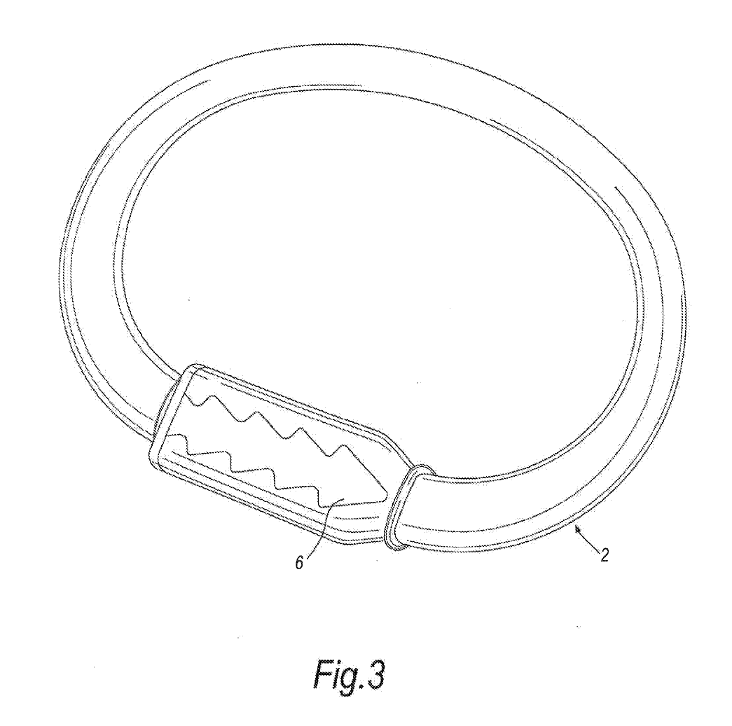

FIG. 3 is a perspective view of the safety link of FIGS. 1 and 2 with its ends engaged to complete the link.

Referring to FIGS. 1 and 2, in particular, a device for forming a safety link according to the present invention is in the form of a plastics, longitudinally elongate member having a first end portion 4 and a second end portion 6. The first end portion 4 is in the general form of a rectangular prism in which is formed a recess 8 defined by sidewalls 10 and 12 and floor 14. The sidewalls 10, 12 are non-planar having a saw-tooth profile as viewed from above the recess 8. The floor 14 has a central recess has a depression whose width and depth each tapers inwards from the open end of the recess effectively forming a hinge 16 connecting the sidewalls 10, 12 of the recess 8 and as best seen in FIG. 2.

The second end portion 6 has sidewalls 18 and 20 which are complementary in shape to sidewalls 10 and 14 of the recess 8 and which is a push fit into the recess 8 to form a safety link as shown in FIG. 3.

In this embodiment the sidewalls 10, 12, 18, 20 have a replicating pattern of the same saw-tooth profile so that the first end portion 4 can fit within the recess 8 in four distinct positions.

The second end portion 6 has a neck portion 22 which has the smallest cross-section of the link 2 which provides a controlled failure point.

The illustrated device is used as follows. The elongate member 2 is formed as a link in a horse restraint by placing it in position and push-fitting the second end portion 6 into the recess 8 of the first end portion 4 in a transverse direction to form a completed safety link as shown in FIG. 3, or in one of the other three possible positions.

If a longitudinal force is applied to the first and second end portions 4 and 6 acting to pull them apart, the complimentary saw-tooth sidewalls produce a lateral force acting to open the top of the recess, ie the sidewalls 10, 12 of the recess 8 to rotate outwards relative to the floor 14 of the recess 8. As the flat surfaces of the saw-tooth profiles of the recesses sidewalls 10 and 12 are splayed outwards, the longitudinal force pulling the first and second end portions 4, 6 apart acts to urge the second end portion 6 out of the recess until it is no longer restrained from longitudinal movement whereupon the safety link 2 opens to release the horse. Typically, the link will be designed to come apart on the application of a force of about 80 Newtons for use with a large horse.

If the link 2 is not opened by excessive forces applied by the horse it can be readily removed for reuse by manually pulling the second end portion 6 transversely out of the recess 2.

1. A device which can be formed into safety link comprising a flexible, longitudinally elongate member having engageable first and second portions; the first end portion including a recess which is open-ended in the longitudinal direction and defined, at least in part, by a pair of opposed interior side walls; the second end portion having sidewalls that are complementary to the sidewalls of the recess so that the second end portion is a push-fit in the recess; at least one pair of the complementary sidewalls being non-planar so as to retain the first end portion in the recess against a longitudinally applied force until it is sufficient to move the sidewalls of the recess apart to release the second end portion from the recess.

2. A device as claimed in claim 1, in which the non-planar sidewalls are corrugated with a repeating pattern so that the second end is push-fit engageable in two or more longitudinal positions within the recess.

3. A device as claimed in claim 2, in which the sidewalls of the recess are more readily moved apart nearer the open end of the first end portion.

4. A device as claimed in claim 3, integrally formed of a plastics material.

5. A device as claimed in claim 3 in which the floor of the recess has a depression whose width and depth each tapers inwards from the open end of the recess.

6. A device as claimed in claim 1, the second end portion including a region of reduced thickness defining the weakest portion of the member.

7. (canceled)

8. A device as claimed in claim 4 in which the floor of the recess has a depression whose width and depth each tapers inwards from the open end of the recess.
